(19) United States
(12) Patent Application Publication
(10) Pub. No.: US 2022/0353765 A1
(43) Pub. Date: Nov. 3, 2022

(54) Active Mobility Into Enterprise Network with Multi-Operator Core Network Gateway

(71) Applicant: Celona, Inc., Cupertino, CA (US)

(72) Inventors: Srinivasan Balasubramanian, San Diego, CA (US); Mehmet Yavuz, Palo Alto, CA (US)

(21) Appl. No.: 17/733,096

(22) Filed: Apr. 29, 2022

Related U.S. Application Data
(60) Provisional application No. 63/182,584, filed on Apr. 30, 2021.

(51) Int. Cl. H04W 36/08; H04W 36/00

(52) U.S. Cl. CPC H04W 36/08; H04W 36/0085; H04W 36/0061

(57) ABSTRACT

A method is disclosed for systems in which the enterprise network is connected to a MOCN GW and in which the enterprise core provides enterprise network addresses for each of the enterprise BS/APs to the MOCN GW together with the associated Cell-ID to allow the MOCN GW to cross-reference the addresses of the enterprise BS/APs from Cell-IDs. A Handover Request is sent in S1AP messaging protocol with a new field for the Cell-ID of the target BS/AP. The MNO source BS/AP receives the Cell-IDs of potential enterprise target BS/APs from the UE. The MNO source BS/AP determines an enterprise target BS/AP. A Handover Request having a field carrying the Cell-ID of the target BS/AP is sent from the MNO source BS/AP to the MOCN GW. The MOCN GW uses the Cell-ID to determine the full IP address within the enterprise network of the target BS/AP.

### CROSS-REFERENCE TO RELATED APPLICATIONS—CLAIMS OF PRIORITY

This utility application (ATTY. DOCKET NO. CEL-031-PAP) claims priority under 35 USC section 111 (b) and under 35 USC section 119 (e), to earlier-filed provisional application No. 63/182,584 filed Apr. 30, 2021, entitled “Active Mobility Into Enterprise Network with Multi-Operator Core Network Gateway” (ATTY. DOCKET NO. CEL-031-PROV); and the contents of the above-cited earlier-filed provisional application (App. No.: 63/182,584) are hereby incorporated by reference herein as if set forth in full.

### BACKGROUND

### (1) Technical Field

The disclosed method and apparatus relate generally to communication systems. In particular, the disclosed method and apparatus relate to providing mobility within networks with a Multi-Operator Core Network Gateway and connectivity to a Mobile Network Operator core and a private network core.

### (2) Background

FIG. 1 shows a basic configuration for a communication network 100, such as a “4G LTE” (fourth generation Long-Term Evolution) or “5G NR” (fifth generation New Radio) network, in which user equipment (UE) 101 communicates with network resources, such as a server 102. In some cases, the server is capable of hosting features and applications that can be made available to the UE 101. The communication between the UE 101 and the server 102 is provided through a base station/access point (BS/AP) 103 and the MNO core 105. The term UE refers to a wide array of devices having wireless connectivity, such as a cellular mobile phone, Internet of Things (IoT) device, virtual reality googles, robotic device, autonomous driving machine, smart barcode scanner, and communications equipment, etc. Communications equipment includes desktop computers, laptop computers, tablets and other types of personal communications devices.

FIG. 2 is a simplified illustration of some of the components of a UE 101. The UE 101 has a processor 110 coupled to a user interface 111 and a transceiver 112. The user interface 111 allows the processor 110 to interact with a user by receiving inputs from the user and providing visual and auditory outputs to the user. The transceiver 112 comprises a receiver 114 and a transmitter 116 that are each coupled to an antenna 118. The combination of the antenna 118 and the transceiver 112 allow the processor 110 to communicate wirelessly with a BS/AP.

Throughout this disclosure, the term BS/AP is used broadly to include at least: (1) an eNB (Evolved Node B or E-UTRAN Node B) of a 4G network; (2) a gNB (5G node B) of an LTE/5G network; (3) a cellular base station (BS); (4) a Citizens Broadband Radio Service Device (CBSD); (5) a WiFi access node; (6) a Local Area Network (LAN) access point; (7) a Wide Area Network (WAN) access point, etc. The term BS/AP should also be understood to include other network receiving hubs that provide wireless access to a network via a plurality of wireless transceivers.

In some cases, a UE 101 uses a BS/AP 103 to gain access to a plurality of networks that in turn provide access to other devices and services. These networks may consist of both public networks and enterprise networks, both of which are supported by the industry standards that define 5G technology. Public networks include networks that are open to any subscriber, such as cellular networks. Enterprise networks are typically networks for which access is restricted to members of a particular organization or “enterprise”, such as a network established by a company for use by their employees. Network administrators typically determine whether a particular UE has access to the network. In many such cases, access is controlled by allowing access to only those UEs to whom proper credentials have been provided by the network administrator. Often, the credentials comprise a digital code that is encrypted on a Subscriber Identification Module (SIM) card. The BS/AP 103 is coupled to a core 105 that manages traffic through the BS/AP 103 and connectivity (i.e., access) to resources, such as the internet 107.

FIG. 3 is an illustration of a larger network 304, such as a 4G or 5G cellular network operated by an MNO (sometimes referred to as a wireless service provider). Within the geographic operating area of the MNO network 304, an enterprise network 308 may be established by a private network operator, such as an enterprise network operator (ENO). BS/APs 103a of the MNO network 304 may service a plurality of UEs 101. Each UE 101 may be present within a coverage area of the MNO network 304 that operates on a first frequency f1. In some cases in which the enterprise network 308 is located within the geographic coverage area of the MNO network 304, one or more enterprise network BS/APs 103 may provide connectivity over a second frequency, f2 to allow UEs 101 within the geographic coverage area to access the enterprise network 308. Alternatively, MNO BS/APs 103b within the enterprise network provide wireless connectivity between the UE 102b within the operating area of the enterprise network 308 and an enterprise Evolved Packet Core (EPC, hereafter referred to simply as a “core”).

When a UE 102 enters an enterprise network campus while communicating with the MNO network through an MNO BS/AP 103, it may desireable for the UE 102 to gain access to either the enterprise network or to the MNO network through an enterprise network BS/AP 303. In this case a handover between the MNO BS/AP 103 and the enterprise BS/AP 303 is desirable. However, currently there is no mechanism in place to allow the MNO core 105 to communicate with an enterprise network BS/AP 303 to handover the UE 102. That is, the MNO core 105 is unaware of the architecture and composition of the enterprise network. Even though the enterprise BS/AP 303 transmits information to assist in identifying the BS/AP 303, the MNO network has no means by which to address the enterprise BS/AP 303. Such communication is needed to successfully complete a handover from the MNO BS/AP 103 to the enterprise BS/AP 303.

Because there is current no way for an MNO core to easily determine the enterprise target BS/AP within the enterprise network, it would be advantageous to provide a system that allows an MNO core to communicate with an enterprise target BS/AP.

### SUMMARY

Some enterprise networks offer a service that allows their subscribers to establish a communication link to an MNO network's infrastructure through the physical radio infrastructure of the enterprise network. A gateway, such as a MOCN gateway (GW), resides between the BS/AP each network core that is accessible to a UE through the BS/AP. If the BS/AP is part of the enterprise network, the BS/AP is connected directly to the enterprise core. Therefore, packets can flow directly from the enterprise BS/AP to the enterprise core. However, packets that are intended for the MNO core will flow through the MOCN GW, which directs packets that flow from the UE through the BS/AP to an appropriate network core. However, the MNO core does not know the internal addresses of the component of the enterprise network. Therefore, the MNO core relies on the MOCN GW to resolve the addresses for the components of the enterprise network with which the MNO core is attempting to communicate.

Enterprise BS/APs transmit a Cell-ID. Accordingly, a UE can determine the Cell-ID of a BS/AP from signals that the UE receives from the BS/AP. However, knowledge of the Cell-ID by itself is not sufficient to allow a device that is not within the enterprise network to communicate with the enterprise BS/AP. Nonetheless, in some embodiments of the disclosed method and apparatus, the Cell-ID is used to access an enterprise address for the enterprise BS/AP. In systems in which the enterprise network is connected to a MOCN GW, the enterprise core provides enterprise network addresses for each of the enterprise BS/APs to the MOCN GW together with the associated Cell-ID to allow the MOCN GW to cross-reference the addresses of the enterprise BS/APs from Cell-IDs. In some embodiments, an X2 gateway is aware of the mapping between the Cell-ID and address of the enterprise BS/APs. Therefore, the X2 interface between the enterprise BS/APs and the X2 gateway can be used for communications between enterprise BS/APs. The communication through the MOCN GW occurs over an S1 interface between the source BS/AP and the MOCN GW. In one embodiment of the disclosed method and apparatus, in an LTE 4G network, the Handover Request can be sent is using an S1AP messaging protocol. The S1 Application Protocol (S1AP) provides the control plane signaling between BS/APs and the MNO core and also provides for S1AP transparent containers to allow communications between BS/APs. In accordance with the presently disclosed method and apparatus, a new field is provided in the S1AP messaging protocol to allow the Cell-ID of the target BS/AP within the enterprise network to be identified. In one embodiment, the MNO source BS/AP receives the Cell-IDs of potential enterprise target BS/APs from the UE. In some embodiments, the MNO source BS/AP determines which of the enterprise BS/APs would be an appropriate enterprise target BS/AP. A Handover Request having a field carrying the Cell-ID of the target BS/AP is sent from the MNO source BS/AP to the MOCN GW. The MOCN GW uses the Cell-ID received from the MNO source BS/AP in the new field provided in the S1AP messaging protocol to allow the Cell-ID of the target BS/AP within the enterprise network to be identified to determine the full IP address within the enterprise network of the target BS/AP. The MOCN GW can then send the Handover Request to the target BS/AP to cause the target BS/AP to allocate the required resources. That is, the same payload provided in the Handover Request sent to the MOCN GW can be sent to the target BS/AP in the enterprise network. In addition, messaging is sent through the MOCN GW to the MNO core (e.g., the MME within the MNO core) to inform the MNO MME that the UE is moving to the target BS/AP. Appropriate bearers are then established between the MNO core and the target BS/AP through the MOCN GW. The MNO source BS/AP can then send a Handover Command to the UE.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 shows a basic configuration for a communication network.

FIG. 2 is a simplified illustration of some of the components of a User Equipment (UE).

FIG. 3 is an illustration of a larger network configuration.

FIG. 4 shows a first configuration in which a UE within the coverage area of an enterprise network can communicate with either an enterprise core of an MNO core through either an enterprise BS/AP or an MNO BS/AP.

FIG. 5 is a simplified illustration of some of the components of a MOCN GW

FIG. 6 shows a second configuration in which a UE within the coverage area of an enterprise network can communicate with either an enterprise core of an MNO core through either an enterprise BS/AP or an MNO BS/AP.

FIG. 7 is a simplified block diagram of the components of a core, such as the MNO core shown in FIG. 3.

FIG. 8 is a simplified flow chart of the process that takes place between the elements of the communications system.

FIG. 9 is a simplified diagram of a communications environment in which an enterprise network and an MNO network communicate through a MOCN GW.

FIG. 10 illustrates the procedure used in accordance with some embodiments of the disclosed method and apparatus.

STEP 11 is an illustration of the messages sent to perform a handover between an MNO source BS/AP and an enterprise target BS/AP.

FIG. 12 shows another embodiment of the disclosed method and apparatus in which, prior to sending a Handover Required message, the MNO MME sends a message to the MOCN GW requesting that the MOCN GW provide a list of enterprise BS/APs that are near the UE.

FIG. 13 is a flowchart showing the steps of an alternative embodiment for performing the handover from an 5G NR MNO source BS/AP to an enterprise target BS/AP using a closed access group identifier (CAG ID).

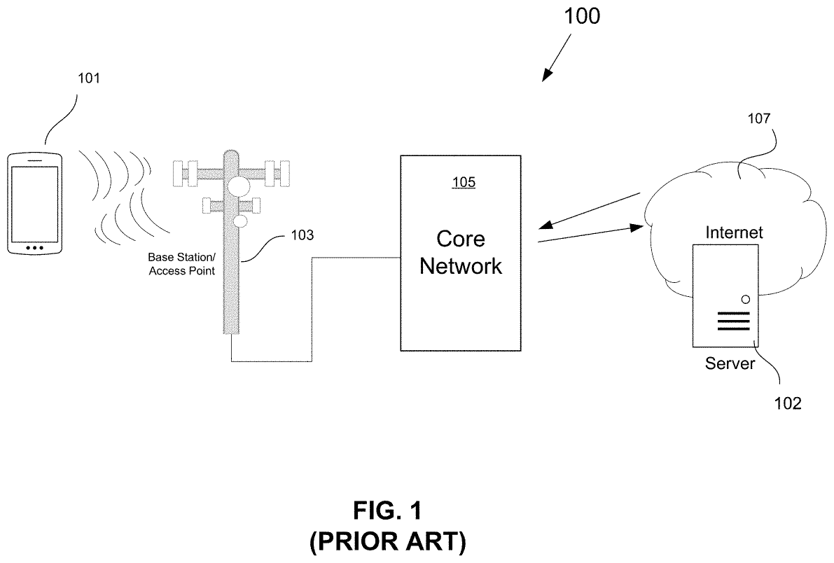

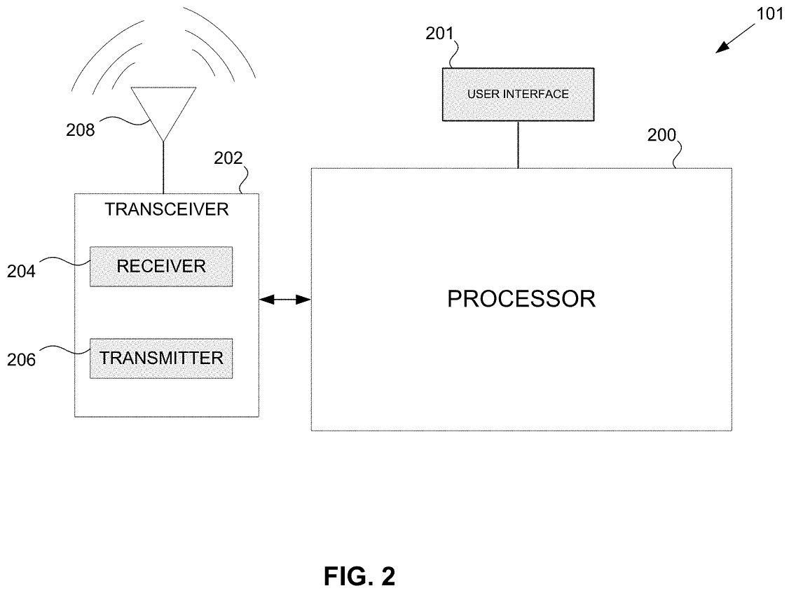

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

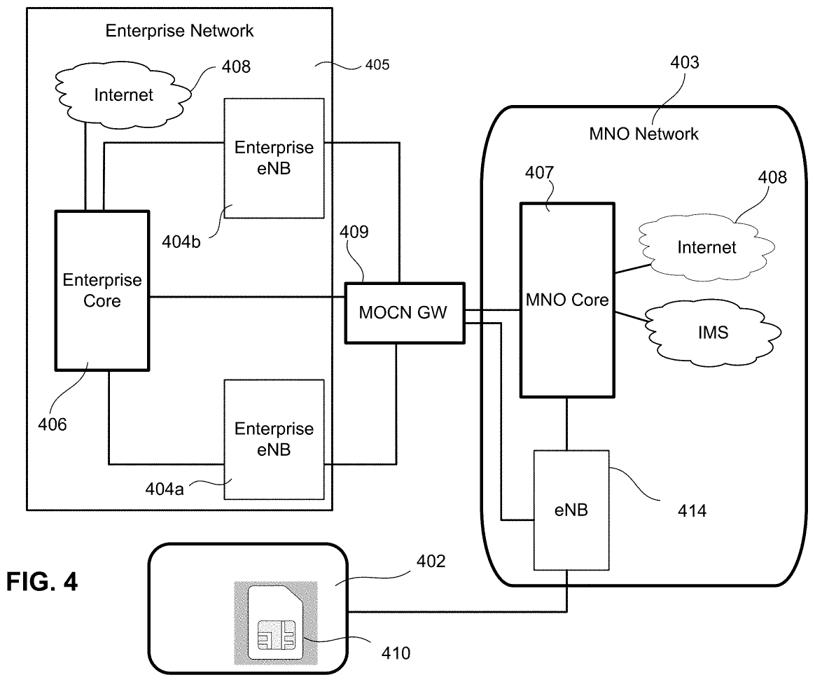

FIG. 4 shows a configuration in which a UE 402 within the coverage area of an enterprise network can communicate with the MNO network through an enterprise BS/AP (e.g., CBSD). It should be noted that the BS/APs of the current systems may be any type noted above, such as eNBs of a 4G LTE network or gNBs of a 5G NR network that are installed and operated by the enterprise network administrator.

Some enterprise networks 405 offer a service that allows their subscribers to establish a communication link to an MNO network's infrastructure (e.g., an MNO core 406) through the physical radio infrastructure (i.e., BS/AP) of the enterprise network. An architecture in which more than one cores 406, 407 can be accessed through the BS/AP of another network is commonly referred to as a Multi-Operator Core Network (MOCN). In such cases, a gateway, such as a MOCN gateway (GW) 409, resides between the BS/AP 404 and one or more cores, each of the cores being accessible by a UE 402 through the BS/AP 404.

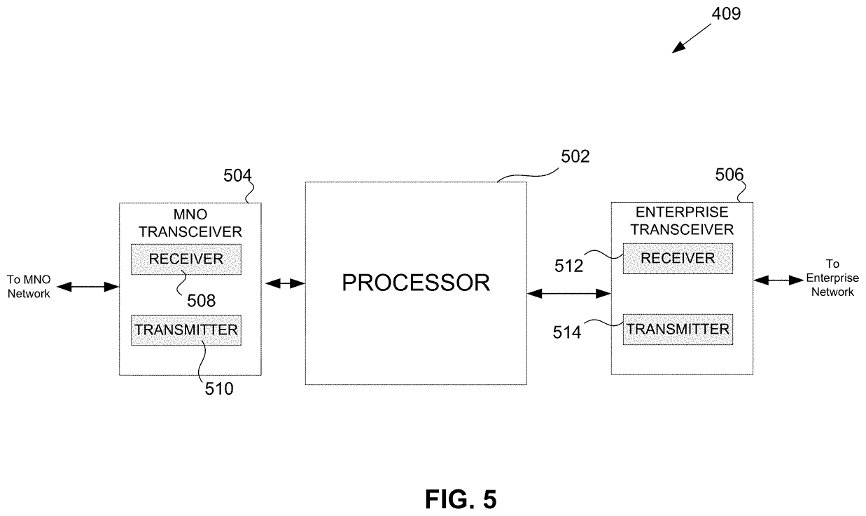

FIG. 5 is a simplified illustration of some of the components of a MOCN GW 409. The MOCN GW 409 comprises a processor 502 coupled to an MNO transceiver 504 and an enterprise transceiver 506. The MNO transceiver 504 comprises an MNO receiver 508 and an MNO transmitter 510. The MNO receiver 508 is configured to receive communications from components of the MNO network 403. The MNO transmitter 510 is configured to transmit communications to components of the MNO network 403. Similarly, the enterprise receiver 504 is configured to receive communications from components of the enterprise network 405. The enterprise transmitter 506 is configured to transmit communications to components of the enterprise network 405. Using the MNO transceiver 504 and the enterprise transceiver 506, the MOCN GW 409 provides a means through which the MNO network components can communicate with the enterprise network components. The processor 502 provides a means for managing the communications between the MNO network components and the enterprise network components.

In some cases in which the BS/AP 404 is part of the enterprise network 405, the BS/AP 404 is connected directly to the enterprise core 406. Therefore, packets can flow directly from the enterprise BS/AP 404 to the enterprise core 406. Nonetheless, packets that are intended to flow between the UE 402 and the MNO core 407 (or for which such flow would be desirable) will flow through the MOCN GW 409, which directs packets that flow from the UE 402 through the BS/AP 404 to the appropriate core 407.

It should be noted that throughout this disclosure, communications are discussed in which “packets” are “routed”, “transmitted” and “received”. However, packets are merely one example of communications and embodiments are not limited to packets, as communications may take other forms as well.

From the perspective of the MNO core 407, the MOCN GW 409 looks like the enterprise network. In some embodiments, MNO network components that are connected to the MOCN GW 409 address the MOCN GW 409 using a 20 bit address. If the MNO component (such as the MME within the MNO core 407) is attempting to access any of the enterprise network components (such as an enterprise BS/AP) the MNO component will direct the communication to the enterprise network by providing the 20 bit address of the MOCN GW 409. That is, messages sent from the MNO core 407 that are addressed to a device within the enterprise network, such as the enterprise core 406 or an enterprise BS/AP 404 are sent to the MOCN GW 409. The processor 502 within the MOCN GW 409 receives communications from the MNO receiver 508. The processor then determines the local enterprise network IP address of the component in the enterprise network for which the communication is intended. The processor 502 then provides the communication with the appropriate local enterprise network IP address to the enterprise transmitter 514, which in turn sends the communication to the addressed component of the enterprise network 405. In order for the MOCN GW 409 to determine the local enterprise network IP address of the particular network component to which the communication is to be routed, the MOCN GW 409 requires additional information. In some embodiments of the disclosed method and apparatus, when a MOCN GW 409 is attempting to communicate with a particular enterprise BS/AP, the unique Cell-ID of that particular enterprise BS/AP can be used by the MOCN GW 409 to determine the local address within the enterprise network of the enterprise BS/AP. In some such embodiments, the MOCN GW 409 maintains a cross-reference between the Cell-IDs of BS/APs of an enterprise network to which the MOCN GW 409 has been assigned a local enterprise network IP address and the local enterprise network IP address of the BS/AP. In some embodiments, the local enterprise network IP address is a 28 bit address that the MOCN GW 409 can attain using this cross-reference to the Cell-ID of the BS/AP.

When a response is sent from the enterprise network component to the MOCN GW 409, the MOCN GW 409 relays that message to the MNO core 407 transparently (i.e., as though the MNO core 407 were directly communicating with the enterprise network 405). However, the MNO core 407 does not know the internal addresses of the component of the enterprise network 405. Therefore, the MNO core 407 relies on the MOCN GW 409 to resolve the local enterprise network IP addresses for the components of the enterprise network 405 with which the MNO core 407 is attempting to communicate.

The MNO BS/APs 414 are directly connected to the MNO core 407, 303, but can only communicate with the enterprise network core 406 and enterprise BS/APs 404 through the MOCN GW 409. In FIG. 4, the UE 402 is shown communicating wirelessly with the MNO BS/AP 414.

While only one MNO core 407 is shown, it should be understood that there may be other such cores as well. An enterprise network subscriber UE (hereafter, simply referred to as a “EUE”) 402 within the coverage area of an enterprise network 405 may be connected to the enterprise BS/AP 404. The MNO BS/AP 404 is part of the enterprise network 405; but is also connected to the MNO network 403 through the MOCN GW 409. Accordingly, the enterprise BS/AP 404 can be used to connect the UE 402 to the MNO network's core 407 (i.e., allow communications to flow between the UE 402 and the MNO core 407).

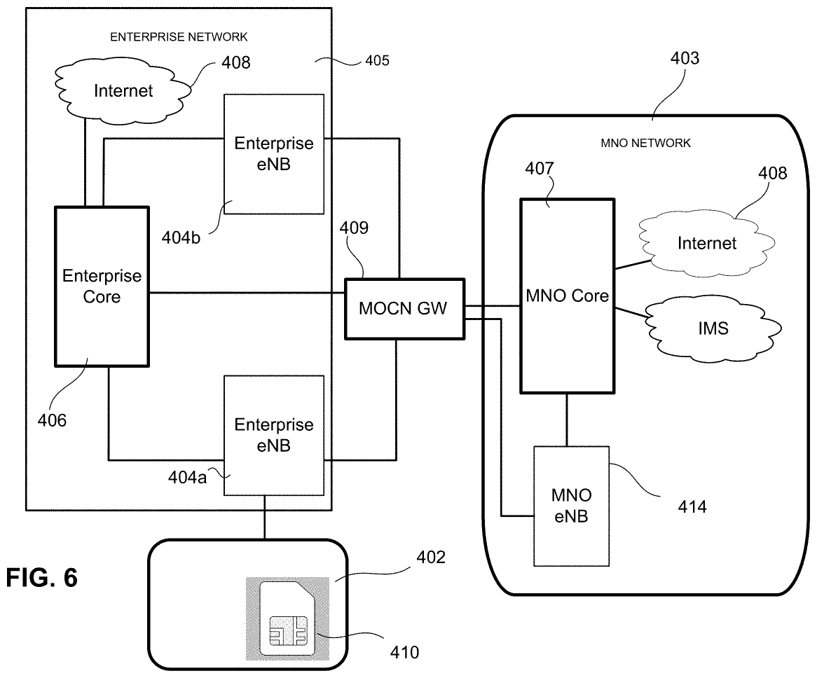

FIG. 6 is similar to FIG. 4, however, the UE 402 is communicating wirelessly through an BS/AP 404a of the enterprise network in the case shown in FIG. 6.

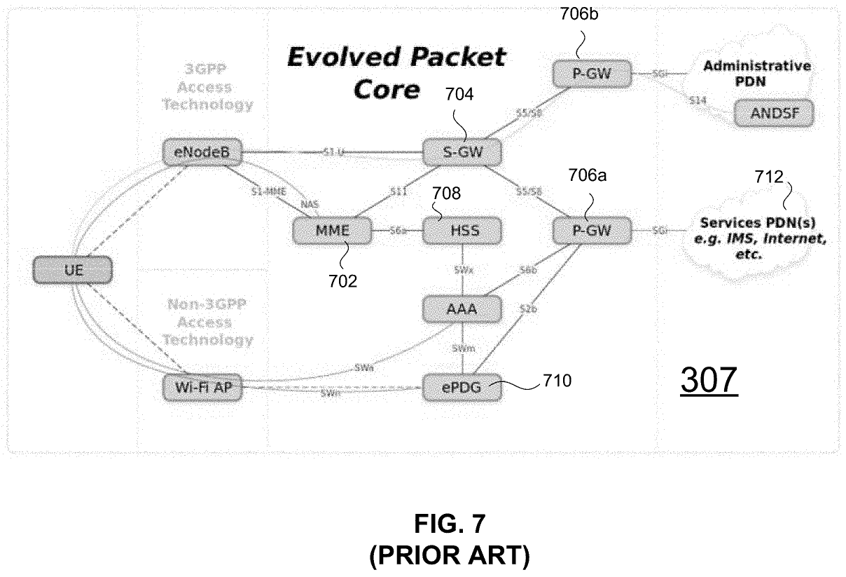

FIG. 7 is a simplified block diagram of the components of a core, such as the MNO core 407 shown in FIG. 4 and FIG. 6. The core 407 comprises an MME (Mobility Management Entity) 702, SGW (Serving Gateway) 704, at least one PGW (Packet Gateway) 706, HSS (Home Subscriber Server) 708, ePDG (evolved Packet Data Gateway) 710, etc. The SGW routes data packets between the UE 402 and a Packet Data Network (PDN) 712. Accordingly, the MNO core 407 can establish a connection to an outside PDN 712 and thus provide connectivity to the internet 408 or to other external services. That is, while the EUE 402 uses the enterprise BS/AP 404, the MOCN GW 409 provides access to the MNO core 407 to allow the EUE 402 to control data flows to the MNO's core 407 and to control access to resources that are available through that MNO's core 407.

Handover from Enterprise Bs/Ap to Enterprise Bs/Ap

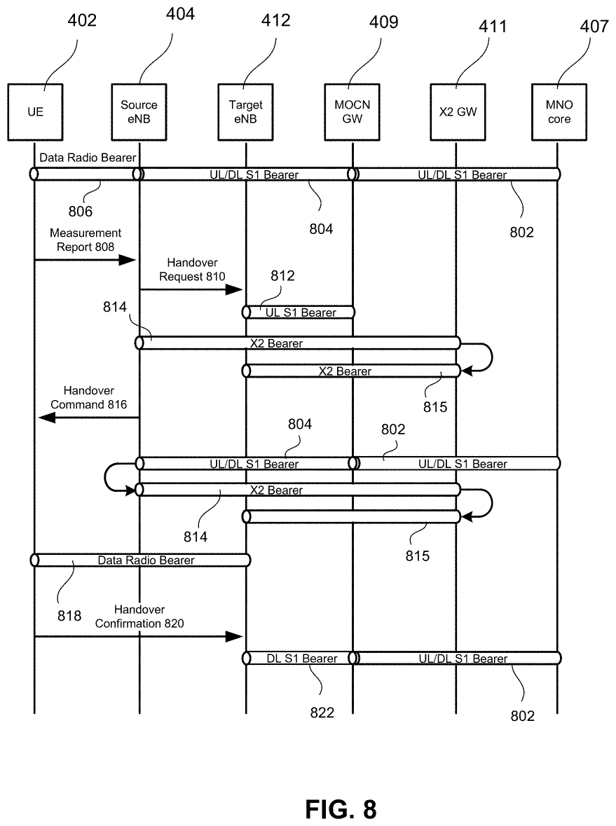

FIG. 8 is a simplified flow chart of the process that takes place between the elements of the communications system when a UE that is already connected to the enterprise network through a first enterprise BS/AP and which is receiving services from the MNO core 407 is handed off to a second enterprise BS/AP. Reference may also be made to FIG. 4 during this discussion.

Initially, traffic between the MNO core 407 and the UE 402 traverses a path that flows through three different bearers (connection paths). The first of these three paths is an S1 bearer 802 between the enterprise core 407 and the MOCN GW 409. The second is an S1 bearer 804 between the MOCN GW 409 and an enterprise source BS/AP 404a. The third is a data radio bearer 806 between the source BS/AP 404a and the UE 402. It should be noted that the assumption is that these three bearers 802, 804, 806 had been previously established to allow communications between the UE 402 and the MNO core 407. The way that occurs is not relevant to the present discussion. Therefore, for the sake of brevity, is not discussed.

Either on a periodic basis or when the conditions dictate, the UE 402 sends a “Measurement Report” 808 to the source BS/AP 404a (i.e., the BS/AP that is currently providing access for the UE 402 to the MNO network 403) indicating the conditions of the data radio bearer 806 and the condition of radio links to other BS/APs. The conditions are determined based on signals received by the UE 402 from the source BS/AP 404a and from the other BS/APs in the area. Upon the source BS/AP 404a determining from the Measurement Report 808 that there is a more preferred BS/AP available, the source BS/AP 404a sends the preferred BS/AP (hereafter referred to as the “target” BS/AP 404b) a handover request 810.

It should be noted that the enterprise BS/APs each transmit a Cell-ID that has been uniquely assigned to the transmitting BS/AP. Accordingly, the transmitted Cell-ID identifies the transmitting BS/AP. However, knowledge of the Cell-ID by itself is not sufficient to allow a device that is not within the enterprise network to communicate with the enterprise BS/AP transmitting the Cell-ID. Rather, the Cell-ID is used to access a local IP address to the enterprise BS/AP which is securely maintained within the enterprise network. In systems in which the enterprise network is connected to a MOCN GW 409, the enterprise core 406 provides enterprise network addresses for each of the enterprise BS/APs 404 (and other components of the enterprise network that might be reached through the MOCN GW 409) to the MOCN GW 409 together with the associated Cell-ID to allow the MOCN GW 409 to resolve (i.e., cross-reference) the addresses of the enterprise BS/APs from Cell-IDs. The MOCN GW 409 then sends the Handover Request message having the same payload as the payload provided in the Handover Request message sent by the MNO source BS/AP 414 to the MOCN GW 409. Since the handover is between BS/APs that are both within the enterprise network, the addresses of each can be determined by the other. However, this is a secure function that is available only to enterprise network components. In addition, in some embodiments, an X2 gateway (not shown in FIG. 4 and FIG. 6, but referenced in FIG. 8) is aware of the mapping between the Cell-ID and address of the enterprise BS/APs 404. Therefore, the X2 interface between the enterprise BS/APs and the X2 gateway can be used for communications between enterprise BS/APs. The communication through the MOCN GW 409 occurs over an S1 interface between the enterprise source BS/AP 404a and the MOCN GW 409.

In response to the handover request 810, (whether received via the MOCN GW 409 over an S1 interface to the enterprise target BS/AP 404b or via the X2 gateway over the X2 interface to the target BS/AP 404b) the target BS/AP 404b establishes an uplink (UL) S1 bearer 812 (i.e., a secure communications link from the target BS/AP 404b to the MOCN GW 409). Initially, the S1 bearer 812 that is established is only for uplink traffic. At this stage in the procedure, downlink (DL) traffic is not yet supported.

Next, the target BS/AP 404b establishes X2 bearers 814, 815 between the target BS/AP 404b and the source BS/AP 404a through the X2 GW 311. Accordingly, a first X2 bearer 814 is established between the source BS/AP 404a and the X2 GW 311 and a second X2 bearer 815 is established between the X2 GW 311 and the target BS/AP 404b. It should be noted that in some embodiments, the communication link between the enterprise target and source BS/APs 404b, 404a could be established using an S1 protocol and going through the MOCN GW 409. However, in embodiments in which the MOCN GW 409 is not located within the enterprise network, the length of the connection is likely to be greater than is the case if the communication link is over the X2 interface between the enterprise BS/APs 404a and an X2 gateway 311. This is particularly true if the X2 gateway 311 is located within the enterprise campus. In some embodiments, the X2 gateway is relatively close to the enterprise core 406, making the route relatively short and fast.

Having established the connection between the target and source BS/APs 404a, 404b, the source BS/AP 404a sends a handover command 816 to the UE 402. In response, the UE 402 detaches from the source BS/AP 404a and attempts to connect to the target BS/AP 404b. Since a downlink S1 bearer between the MOCN GW 409 and the target BS/AP 404b has yet to be established, the MOCN GW 409 continues to send traffic intended for the UE 402 to the source BS/AP 404a through the S1 bearer 804 to maintain the data flow. However, since the source BS/AP 404a is no longer connected to the UE 402, the source BS/AP 404a caches the data and routes the traffic to the target BS/AP 404b through the established X2 bearer 814 to the MOCN GW 409, which then sends the traffic to the target BS/AP 404b over the X2 bearer between the MOCN GW 409 and the target BS/AP 404b.

In some embodiments, the target BS/AP 404b will not yet be connected to the UE 402 (i.e., confirmation of the handover command 816 is not yet received by the MOCN GW 409). Therefore, the target BS/AP 404b caches the traffic for transmission over the data radio bearer 818 that will soon be established between the UE 402 and the target BS/AP 404b. Once the data radio bearer 818 is established between the target BS/AP 404b and the UE 402, the handover confirmation 820 is sent from the UE 402 to the target BS/AP 404b. Accordingly, data that has been cached by the target BS/AP 404b can be sent to the UE 402 over that data radio bearer 818. The target BS/AP 404b then sends a “path switch request” to the MOCN GW 409 to cause the MOCN GW 409 to switch from the S1 bearer 804 (established with the source BS/AP 404a) to a new 51 downlink bearer 822 to be established from the MOCN GW 409 to the target BS/AP 404b. Upon establishment of the S1 downlink bearer 822, the MOCN GW 409 modifies the packet route to allow packets to flow directly through the downlink S1 bearer 802 from the core 407 to the MOCN GW 409. Traffic then flows through the S1 downlink bearer 822 to the target BS/AP 404b. The target BS/AP 404b then sends the packets on to the UE 402 through the data radio bearer 818. In this way, traffic continues to flow as the handover process is performed without interruption to the traffic.

Handover from MNO BS/AP to Enterprise BS/AP

The presently disclosed method and apparatus provides three embodiments that can be used to facilitate a handover from an MNO source BS/AP to an enterprise target BS/AP. In some embodiments, such a handover is performed when a UE is within (or imminently approaching) the campus of the enterprise network. It should be noted that the BS/APs disclosed herein may be any of the types noted above.

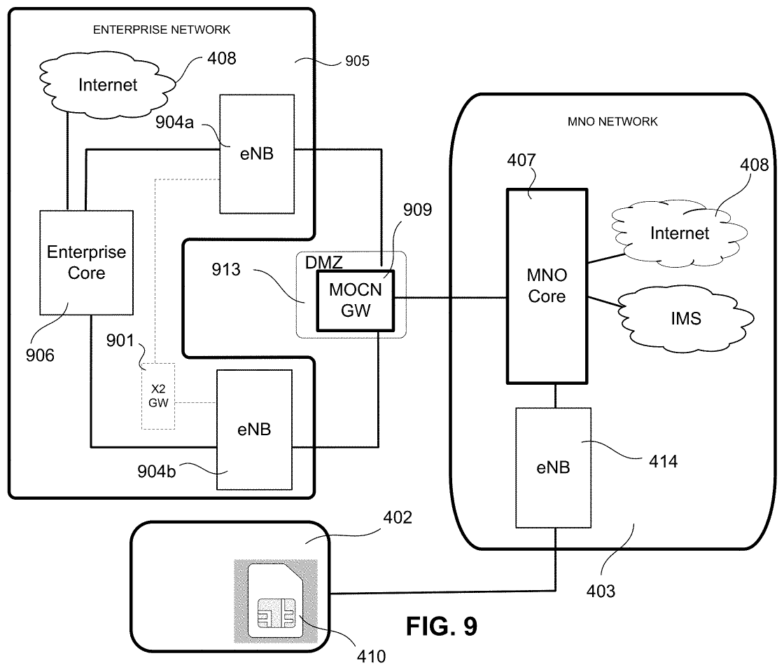

FIG. 9 is a simplified diagram of a communications environment having enterprise network 905 comprising BS/APs 904, and an enterprise core 906 and an MNO network 403 comprising an MNO core 407 and MNO BS/AP 414. The MNO network 403 can communicate with the enterprise network 905 through a MOCN GW 909. In some embodiments, an X2 GW 901 is not required in the enterprise network 905 of the disclosed method and apparatus. However, an X2 GW 901 may be present in alternative embodiments and as such is shown in dotted lines.

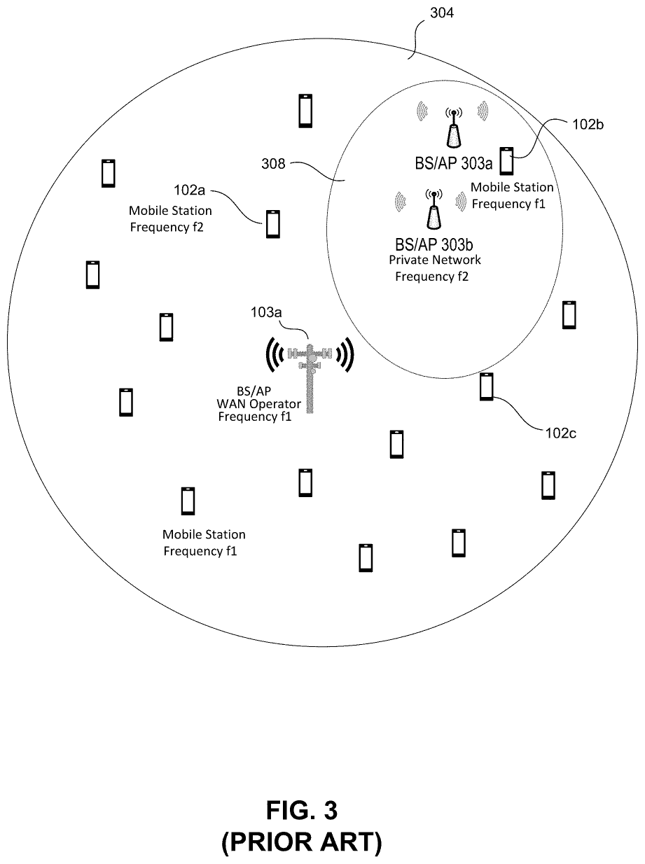

When a UE 402 that is currently camped on an MNO BS/AP 414 approaches an enterprise network campus having a coverage area 308 (see FIG. 3), the UE 402 may be alerted that it is time to start searching for enterprise BS/APs 904. Such an alert can occur in one of several different ways, such as by the UE 402 comparing its GPS (global positioning system) location with a table stored within the UE 402 that maintains the GPS location of campuses of enterprise networks to which the UE 402 is a member. Alternatively, or additionally, the UE 402 may compare the identities of the MNO BS/AP 414 from which the UE 402 can received transmissions to a database that cross references this information with a list of enterprise network campuses. When one or more of the MNO BS/APs 904 that the UE 402 can “see” match an entry in the database associated with a particular enterprise campus, the UE 402 can be considered to be in or near the associated enterprise campus.

Many other techniques can be used to determine that the UE 402 is approaching or within the campus of an enterprise network to which it is a member. In some embodiments, the UE 402 identifies that it is near an enterprise campus based on the particular MNO sites from which the UE 402 is receiving signals. In some such embodiments, a “fingerprint” formed by the relative characteristics of signals received from each MNO site can be matched to a database that cross-references the fingerprint to an enterprise network campus. In some embodiments, signals received from multiple different MNO networks can be used to form the fingerprint.

In some embodiments in which the UE 402 is actively communicating through the MNO BS/AP 414 (i.e., there is ongoing communication and the UE is in the “active state”) the MNO source BS/AP 414 initiates an S1 Application Protocol (S1AP) message exchange based on the UE 402 indicating that it is near an enterprise campus. Alternatively, the MNO source BS/AP 414 receives a message from the MNO core 407 indicating that the UE 402 is near an enterprise campus. In some embodiments, the MNO core 407 requests that the UE 402 measure the signal strength being received by the UE 402 from surrounding BS/APs.

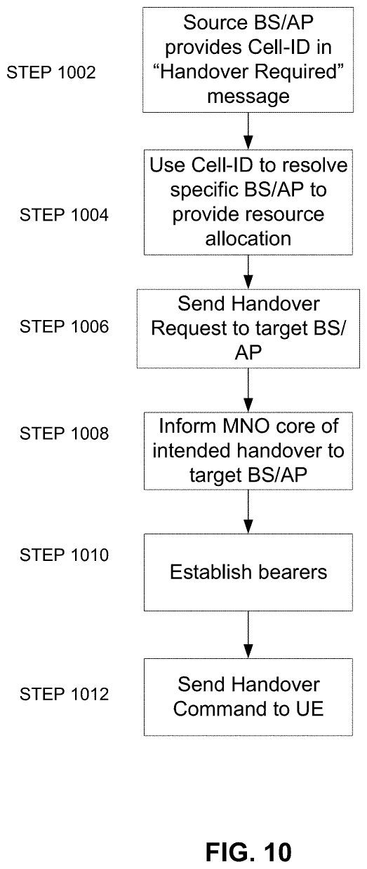

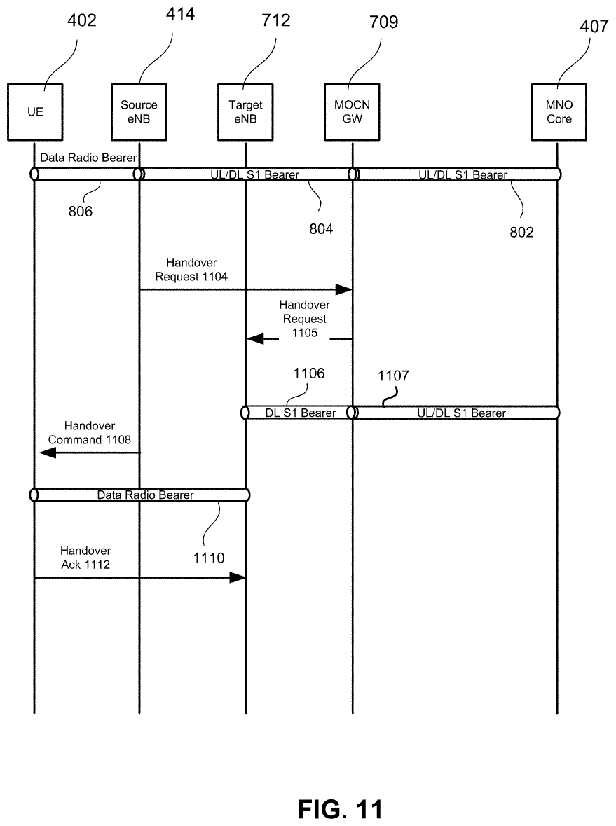

FIG. 10 illustrates the procedure used in accordance with some embodiments of the disclosed method and apparatus. Upon a determination that the UE is near an enterprise campus, an S1AP message exchange is initiated in which the S1AP messaging is altered from a conventional message in order to have the Cell-ID of an enterprise target BS/AP included in the messaging (STEP 1002).

FIG. 11 is an illustration of the messages sent to perform a handover between an MNO source BS/AP 414 and an enterprise target BS/AP 904. The Handover Request 1104 is sent by the MNO source BS/AP 414 through the MOCN GW 909 to the target BS/AP 904 when it is determined that the UE 402 is sufficient near an enterprise campus of an enterprise network to which the UE 402 has a subscription (i.e., is authorized). As noted above, there are several ways well known to those of ordinary skill in the art that can be used to make that determination. The particular manner used to make that determination is not necessarily relevant to this disclosure.

In one embodiment of the disclosed method and apparatus, in an LTE 4G network, the Handover Request 1104 can be sent is using an S1AP messaging protocol. The S1AP provides the control plane signaling between BS/APs and the MNO core 407 and also provides for S1AP transparent containers to allow communications between BS/APs. The S1AP protocol is defined in TS 36.413, as published by 3GPP (third generation partnership project).

However, the information that can be sent in accordance with the S1AP protocol does not provide the MOCN GW 909 with sufficient information to communicate with the target BS/AP 904. That is, the local enterprise network IP address of enterprise BS/APs are not known outside the enterprise network. Therefore, in accordance with the presently disclosed method and apparatus, when the combination of UE, MNO source BS/AP and MNO core 407 determine that it would be appropriate to perform a handover from a source BS/AP to an enterprise BS/AP, the messaging to the target enterprise BS/AP flows through the MOCN GW 409 and includes the Cell-ID of the target BS/AP. Previous SLAP messaging did not have a means by which to provide this information. Therefore, without the disclosed method and apparatus, there is no way to set up the resources in the enterprise target BS/AP and complete the handover procedure. That is, when the source BS/AP is an MNO BS/AP 404 and the target BS/AP is an enterprise BS/AP 904, there is no way for the MNO source BS/AP 414 to communicate with an enterprise target BS/AP 904. Any communication from components of the MNO network 403 will only have sufficient information to address the MOCN GW 909. The MOCN GW 909 is then responsible to “fill in” the rest of the address to which the messaging is to be sent. Without the presently disclosed method and apparatus, the MOCN GW 909 does not have sufficient information to determine the local enterprise IP address of the enterprise BS/AP to which the MME 702 (see FIG. 7) is attempting to perform the handover.

In accordance with the presently disclosed method and apparatus, in order to resolve this problem, a new field is provided in the S1AP messaging protocol to allow the Cell-ID of the target BS/AP 904 within the enterprise network to be communicated to the MOCN GW 909. In one embodiment, the MNO source BS/AP 414 receives the Cell-IDs of potential enterprise target BS/APs 904 from the UE 402. In some embodiments, the MNO source BS/AP 414 determines which of the enterprise BS/APs 904 would be an appropriate enterprise target BS/AP. A Handover Request 1104 (in some embodiments in accordance with the modified S1AP protocol) having a field carrying the Cell-ID of the target BS/AP 904 is sent from the MNO source BS/AP 414 to the MOCN GW 909 (STEP 1002).

In some embodiments, when communications from any component of the MNO network 403 are sent to a component of the enterprise network 905, such as to the target BS/AP 904, such messages are sent through the MOCN GW 909. The MOCN GW 909 uses the Cell-ID received from the MNO source BS/AP 414 (e.g., in the new field provided in the SLAP messaging protocol) to allow the Cell-ID of the target BS/AP 904 within the enterprise network to be known to the MOCN GW 909 so it may determine the full local enterprise IP address of the BS/AP within the enterprise network to which the message is intended (e.g., the target BS/AP 904) (STEP 1004). The MOCN GW 909 can then send the Handover Request 1105 to the target BS/AP 904 to cause the target BS/AP 904 to allocate the required resources. In some embodiments, the MOCN GW 409 then sends a Handover Request message having the same payload as the payload provided in the Handover Request message sent by the MNO source BS/AP 414 to the MOCN GW 409. In addition, messaging is sent through the MOCN GW 909 to the MNO core 407 (e.g., the MME 702 within the MNO core 407) to inform the MNO MME 702 that the UE 402 is moving to the target BS/AP 904 (STEP 1008). Appropriate bearers 1106, 1107 are then established between the MNO core 407 and the target BS/AP 904 through the MOCN GW 909 (STEP 1010). The MNO source BS/AP 414 can then send a Handover Command 1108 to the UE 402 (STEP 1012). In some embodiments, the S1 bearer 1107 between the MNO core 407 and the MOCN GW 909 may be the same as the previously established 51 bearer 802.

In some embodiments, the MNO core accesses the GPS location of enterprise BS/APs 904 and compares them to the location of the UE 402 to determine whether to initiate a handover from the MNO source BS/AP 414 to an enterprise target BS/AP 904 and to which enterprise BS/AP to designate as the target BS/AP 904. The location of the UE 402 can be determined by any of several techniques, including the UE 402 independently determining its GPS location.

In some embodiments, the GPS locations of enterprise BS/APs 904 are stored in an SMLC (Serving Mobile Location Center) (not shown) to which the MNO core has access. In some embodiments, the handover procedure is initiated only after it is determined that the UE 402 is near or within an enterprise network campus. In some embodiments, a determination that the UE 402 is near one or more of the enterprise BS/APs 904 is sufficient to establish that the UE 402 is in or near the enterprise network campus and to start a handoff procedure from the MNO source BS/AP 414 to an enterprise target BS/AP 904.

In some embodiments, the UE 402 can maintain information about enterprise networks that the UE 402 frequents, such as the location of the BS/APs of that enterprise network, including which particular BS/APs are at the portals to the enterprise network campus, and thus most likely to be an appropriate enterprise target BS/AP for a handover from an MNO source BS/AP 414 to an enterprise target BS/AP 904.

It should be noted that the MNO core 407 can determine the location of the UE 402 by one of several other means for determining position location of a UE. In some embodiments, the enterprise network will be a Neutral Host and the specific MNO network needs to be supported. Neutral Host is a vertical application in which the Neutral Host owns the network infrastructure and provides distinct network slices (i.e., allocatable access to communication resources) that can be managed and monitored. In some embodiments, the MNO network 403 is supported by the Neutral Host enterprise network and as such, can use some allocated distinct network slices of the enterprise network.

In any case, Cell-ID information is used to resolve the specific IP address of the BS/AP within the enterprise network that is required to allow communication with the enterprise target BS/AP and thus request the needed resource allocation.

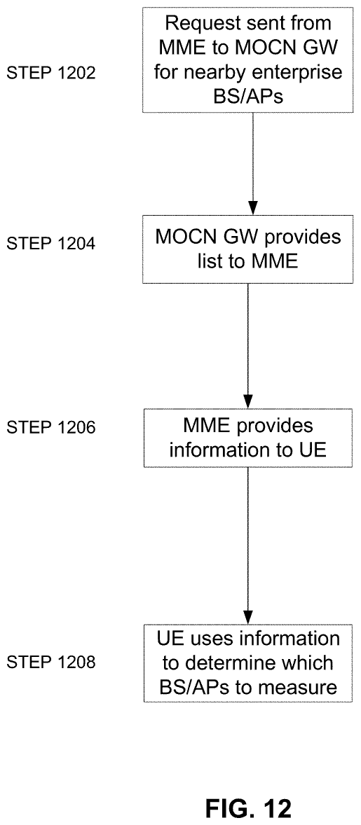

FIG. 12 shows another embodiment of the disclosed method. In addition to the process that is outlined above with respect to FIG. 10, prior to sending a Handover Required message, the MNO MME 702 within the MNO core 407 sends a message to the MOCN GW 909 requesting that the MOCN GW 909 provide a list of enterprise BS/APs that are near the UE 402 (STEP 1202). In some embodiments, the location of the UE 402 (e.g., GPS information regarding the location of the UE 402), is provided by the MME 702 in the request to the MOCN GW 909 (STEP 1204) to assist in narrowing the list of potential enterprise target BS/APs from whom the UE 402 will measure received signal strength.

The MOCN GW 909 provides the list of BS/APs that are near the UE 402 to the MNO core 407 (i.e., the MME 702). The MNO core 407 then provides this information to the UE 402 (STEP 1206). The UE 402 uses this information to determine whether signals received from each enterprise BS/AP are to be measured (STEP 1208). The UE 402 then provides a measurement report to the MNO source BS/AP 414. The report contains measurements of the received signal strength for signals received by the UE 402 from those BS/APs that were present in the list sent to the UE 402 from the MNO core 407 (STEP 1210). In some embodiments, the MNO source BS/AP 414 then selects the enterprise BS/AP with the highest signal strength to be the target BS/AP 904. Alternatively, in some embodiments, the source BS/AP 414 simply indicates to the MNO core 407 which enterprise BS/AP 904 has the strongest signal.

Alternatively, in some embodiments, the MME 702 analyzes of the signal strengths and provides the source BS/AP 414 with the results of the analysis. The source BS/AP 414 then uses that information to assist in determining which BS/AP is most appropriate to be the target BS/AP 904 for handover. In the same fashion as noted above in the discussion of FIG. 10, the source BS/AP 414 sends the handover required message to the selected target BS/AP 904.

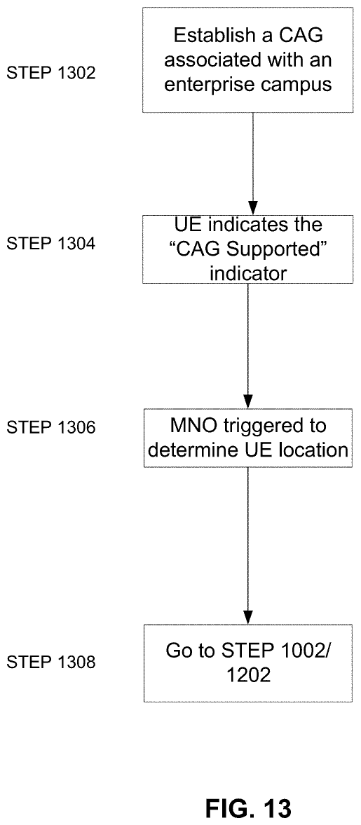

FIG. 13 is a flowchart showing the steps of an alternative embodiment for performing the handover from an 5G NR MNO source BS/AP 414 to an enterprise target BS/AP 904. This embodiment reduces the reliance on the MNO network and uses the preferences of the UE 402 to find campuses and aid the MNO network in performing the handover. In particular, a CAG ID (Closed Access Group IDentifier) identifies a CAG associated with the enterprise network. The CAG is formed to allow authorized UE's to access selected functions within a network. In this case, a CAG is formed and a CAG ID assigned to support functionality related to one or more particular enterprise campuses (STEP 1302). Accordingly, UEs 402 that are authorized to have access to a particular enterprise campus neutral host are considered to be subscribed to the CAG ID without the need for explicit provisioning. That is, if a UE 402 has authorization to use resources of the enterprise campus neutral host (i.e., the enterprise network operating as a neutral host), then that UE 402 is considered to be a subscriber to the CAG ID associated with that particular enterprise campus. Furthermore, MNO networks having a coverage area 304 that overlaps with the coverage area 308 of the enterprise network will recognize the CAG ID as being associated with the enterprise campus where neutral host is enabled.

When the UE 402 is near the enterprise network, the UE 402 provides the “CAG Supported” indication to an AMF (Access and Mobility management Function) within the MNO core 407 (STEP 1304). Receipt of the CAG Supported indication triggers the MNO core 407 to determine the UE's GPS location (STEP 1306). The steps shown in either FIG. 10 or FIG. 12 are then performed (STEP 1308).

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for performing handover of a User Equipment (UE) from a source Base station/Access Point (BS/AP) to an enterprise target BS/AP, the method comprising:
a) receiving a first message from a Mobile Network Operator (MNO) source BS/AP, the first message including a Cell-ID of an enterprise target BS/AP;
b) in response to the received first message, using the Cell-ID of the enterprise target BS/AP to determine the enterprise network IP address of the enterprise target BS/AP; and
c) using the determined enterprise IP address to send a second message to the enterprise target BS/AP.

2. The method of claim 1, wherein the payload of the second message is the same as the payload of the first message.

3. The method of claim 1, wherein the first message is sent in response to the UE approaching an enterprise network that includes the target enterprise BS/AP.

4. The method of claim 3, wherein the source BS/AP receives a message from an MNO core indicating that the UE is approaching the enterprise network.

5. The method of claim 1, wherein a MNO core requests that the MNO source BS/AP perform measurements to determine whether the MNO source BS/AP is to send the first message.

6. The method of 15, wherein the source BS/AP determines, based on the measurements, the Cell ID of the target BS/AP.

7. The method of claim 1, wherein the first and second messages are modified S1AP messages in which the Cell ID of the target BS/AP is provided.

8. A UE comprising:
a) a receiver configured to wirelessly receive signals from BS/APs;
b) a transmitter configured to wirelessly transmit to BS/APs; and
c) a processor coupled to the receiver and to the transmitter, the processor configured to:
i. determine whether the UE is near an a first enterprise BS/AP of an enterprise network for which the UE has credentials;
ii. in response to the determination that the UE is near the first enterprise BS/AP, determining the Cell-ID of the first enterprise BS/AP;
iii. providing information to the transmitter to direct the transmitter to transmit to a first MNO BS/AP that a target enterprise BS/AP has been identified, the information including the Cell-ID of the identified target enterprise BS/AP; and
iv. receiving from the receiver information indicating the UE should begin communicating with the target BS/AP.

9. A MOCN GW configured to facilitate communications between components of an MNO network and components of an enterprise network, the MOCN GW comprising:
a) an MNO receiver configured to receive communications from components of the MNO network;
b) an MNO transmitter configured to transmit communications to components of the MNO network;
c) an enterprise receiver configured to receive communications from components of the enterprise network;
d) an enterprise transmitter configured to transmit communications to components of the enterprise network;
e) a processor coupled to the MNO receiver and transmitter and configured to:
i. receive from the MNO receiver, a first communication from a source MNO BS/AP, the first communication including a Cell-ID of a target enterprise BS/AP;
ii. determining a local enterprise network IP address associated with the target enterprise BS/AP based on the Cell-ID provided in the first communication; and
iii. transmitting through the enterprise transmitter a communication to the target enterprise BS/AP to initiate a handover from the source MNO BS/AP to the target enterprise BS/AP.
